(19) United States
(12) Patent Application Publication
(10) Pub. No.: US 2007/0194838 A1
(43) Pub. Date: Aug. 23, 2007

(54) Current mirror with improved output impedance at low power supplies

(75) Inventor: Paulius Mindaugas Mosinskis, Richlandtown, PA (US)

Correspondence Address: Wendy W. Koba, Esq., PO Box 556, Springtown, PA, 18081, US

(73) Assignee: SiOptical, Inc.

(21) Appl. No.: 11/706,487

(22) Filed: Feb. 15, 2007

Related U.S. Application Data
(60) Provisional application No. 60/774,944, filed on Feb. 17, 2006.

(51) Int. Cl. G05F 1/10

(52) U.S. Cl. 327/543

(57) ABSTRACT

A current mirror circuit arrangement is formed to maintain a high output impedance when utilized with a relatively low voltage power supply. A common mode voltage regulator circuit is utilized in conjunction with the output branch of the current mirror to eliminate the need for an additional active device in series with the output transistor of a current mirror to control its drain voltage. The elimination of the second active device thus increases the available headroom for the output branch (i.e., adds one V_{DS}). The increased headroom in the inventive current mirror is particularly advantageous for low voltage applications, since it is capable of maintaining the high output impedance required for accurate mirroring of the input current.

### CROSS-REFERENCE TO RELATED APPLICATION

This application claims the benefit of U.S. Provisional Application 60/774,944, filed Feb. 17, 2006.

### TECHNICAL FIELD

The present invention relates to a current mirror arrangement and, more particularly, to a current mirror circuit that maintains a high output impedance when utilized with a relatively low voltage power supply.

### BACKGROUND OF THE INVENTION

There are many techniques used to provide regulated current to a load circuit. One technique involves a current mirror. A conventional current mirror provides output current proportional to an input current. Separation between the input and output current ensures that the output current can drive high impedance loads. Conventional current mirror designs have been implemented in both bipolar and MOS technology. MOS devices with short channel lengths (and therefore faster operation) have provided an impetus toward current mirrors based on MOS technology.

An important aspect in designing an MOS current mirror is to achieve optimum matching between the input (or “bias”) current and the output current. Typically, the output current is designed to traverse a load placed across the output terminals of the current mirror. The bias current is generally derived from a current source linked to a bias transistor. The bias transistor receives the bias current and produces a proportional bias voltage. The bias voltage is then placed on an output transistor configured to replicate (or “mirror”) the bias current. Properly mirrored output current assumes the bias transistor and output transistor are fabricated with similar properties.

FIG. 1 illustrates a conventional prior art two-transistor current mirror 1, where a reference current I_{ref1} is provided to a diode-connected reference transistor MN₁ which is mirrored by an output transistor MN₂ to produce an output current Iₒᵤₜ₁. Characteristic of current mirrors, the output current Iₒᵤₜ₁ is substantially equal to reference current I_{ref1} as long as the geometry of reference transistor MN₁ is substantially the same as the geometry of output transistor MN₂. Those skilled in the art can appreciate, however, that the ratio of the output current Iₒᵤₜ₁ to reference current I_{ref1} may be modified by changing the ratio of the geometry of output transistor MN₂ to reference transistor MN₁.

Simple current mirror 1 allows for low-swing operation of an output voltage Vₒᵤₜ₁ of a load, but suffers from poor output resistance. FIG. 2 is a graph which shows the relationship between the output current Iₒᵤₜ₁ along the ordinate direction and the output voltage Vₒᵤₜ₁ along the abscissa. As shown, the response graph of current mirror 1 is divided between a triode region T and a saturation region S, where saturation region S is defined as the region where output voltage Vₒᵤₜ₁ is greater than the saturation voltage V_{DSsat2} of output transistor MN₂. In general, the saturation voltage V_{DS(sat)} is defined as the drain-to-source voltage of a transistor necessary to begin operation of that transistor in the saturation region which is shown as the “knee” of the curve in FIG. 2. While operating in saturation region S, changes in output voltage Vₒᵤₜ₁ at the load have little effect on the output current Iₒᵤₜ₁. However, while operating in triode region T, changes in output voltage Vₒᵤₜ₁ at the load have great effect on the output current Iₒᵤₜ₁. In other words, output voltage Vₒᵤₜ₁ can swing as low as saturation voltage V_{DSsat2} before the output resistance becomes unacceptably affected. Although the simple current mirror 1 provides for a low-swinging output voltage, those skilled in the art can appreciate that the output resistance is still undesirably low while operating in saturation region S.

With reference to FIG. 3, a conventional cascode current mirror 3 is shown in schematic form. A first reference transistor MN₃ and a second reference transistor MN₄, which are diode-connected, form a reference leg RL of cascode current mirror 3. A first output transistor MN₅ and a second output transistor MN₆ from an output leg OL of current mirror 3, where first output transistor MN₅ is defined as the “cascode” transistor and serves to buffer output voltage Vₒᵤₜ₂ swings from first output transistor MN₅ such that first output transistor MN₆ is more likely to remain operating in its saturation region.

Conventional cascode current mirror 3 provides excellent output resistance, but at the expense of a lower swing on the output voltage Vₒᵤₜ₂ (that is, the ability of output voltage Vₒᵤₜ₂ to swing low while maintaining a high output resistance). With reference to FIG. 4, a graph of the relationship between output current Iₒᵤₜ₂ along the ordinate direction and output voltage Vₒᵤₜ₂ along the abscissa is shown. When both the first and second output transistors MN₅, MN₆ are in saturation region S, output current Iₒᵤₜ₂ remains nearly constant as output voltage Vₒᵤₜ₂ changes. In other words, the output resistance is extremely high while output transistors MN₅, MN₆ are saturated. However, as second output transistor MN₆ passes into triode region T, the output resistance decreases (shown in region T1). The output resistance decreases further when both first and second output transistors MN₅, MN₆ pass into triode region T2.

While the output resistance of cascode current mirror 3 is greater than that of simple current mirror 1, the lower limit of the output swing is considerably higher than that of simple current mirror 1. Output resistance of a current mirror is important because it defines how the output current will change as the output voltage changes. Operating the transistors of output leg OL of mirrors 1 and 3 in the saturation region significantly increases the output resistance. Additionally, the use of cascode current mirror 3 increases the output resistance when compared to the simple current mirror 1.

Headroom is important because it defines the range in which the output voltage Vₒᵤₜ₂ may operate. The lowest swing of output voltage Vₒᵤₜ₍ₘᵢₙ₎₂ defines the lower limit of the headroom, while the positive power supply V_{DD} generally defines the upper limit of the headroom. Any load circuit that uses the mirror generally operates within the range defined by the headroom to assure adequate output resistance. Recently, there has been a trend toward lower voltage power supplies V_{DD}. However, reducing the power Supply V_{DD} impinges upon the upper range of the headroom available to the load circuit. Accordingly, there is a need to increase headroom for current mirrors without reducing output resistance.

One approach to addressing the problem of increasing headroom is discussed in U.S. Pat. No. 6,633,198, issued to George R. Spalding, Jr. on Oct. 14, 2003. In this reference, Spalding, Jr. utilizes a “control element” to adjust the drain voltage at an input circuit branch (referring to FIG. 3, the drain voltage of MN₃) as a function of V_{OUT}. While effective in increasing the available headroom by eliminating transistor MN₆, this arrangement still requires the use of multiple active devices along the output circuit branch.

### SUMMARY OF THE INVENTION

The present invention is directed to an improved current mirror circuit arrangement and, more particularly, to a current mirror circuit that maintains a high output impedance when utilized with a relatively low voltage power supply.

In accordance with the present invention, a common mode voltage regulator circuit is utilized in con junction with the output branch of the current mirror to eliminate the need for an additional active device in series with the cascode output transistor to control the output voltage. The elimination of this active device thus increases the available headroom for the output branch—particularly advantageous for low voltage applications—yet maintains the high output impedance required for accurate mirroring of the input current.

In an MOS-based embodiment of the present invention, one MOS device along the output branch of the current mirror is eliminated (thus increasing the available headroom by one V_{DS}) and the drain voltage at the remaining MOS device (i.e., V_{OUT}) is controlled by adjusting the common mode output voltage of the input circuit branch. The arrangement of the present invention may be cascaded to form a multi-stage circuit or, alternatively, may be utilized in conjunction with prior art current mirrors to achieve even greater output impedance values when larger supply voltages are present.

The biasing arrangement within the current mirror of the present invention may be implemented with either MOS devices or bipolar devices, based on other design choices.

Other and further embodiments and advantages of the present invention will become apparent during the course of the following discussion and by reference to the accompanying drawings.

### BRIEF DESCRIPTION OF THE DRAWINGS

Referring now to the drawings, where like numerals represent like elements in several views:

FIG. 1 illustrates a basic prior art current mirror utilizing a pair of transistors;

FIG. 2 is a graph of the output current vs. output voltage of the current mirror of FIG. 1;

FIG. 3 illustrates a prior art cascode current mirror arrangement;

FIG. 4 is a graph of the output current vs. output voltage of the cascode current mirror of FIG. 3;

FIG. 5 is a schematic of an exemplary current mirror circuit formed in accordance with the present invention to provide a high output impedance when used in situations powered by a relatively low voltage;

FIG. 6 illustrates a specific embodiment of the control circuit within the current mirror of the present invention;

FIGS. 7-10 illustrate various alternative embodiments of the present invention, utilizing different interconnections and devices along the input, reference branch of the current mirror; and

FIG. 11 illustrates an exemplary multi-stage cascade arrangement of the current mirror of the present invention.

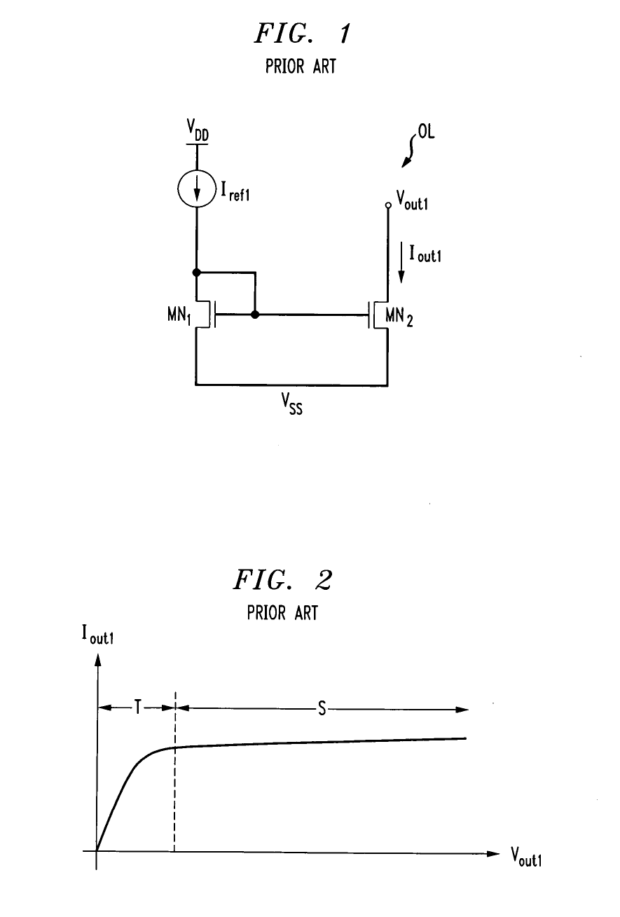

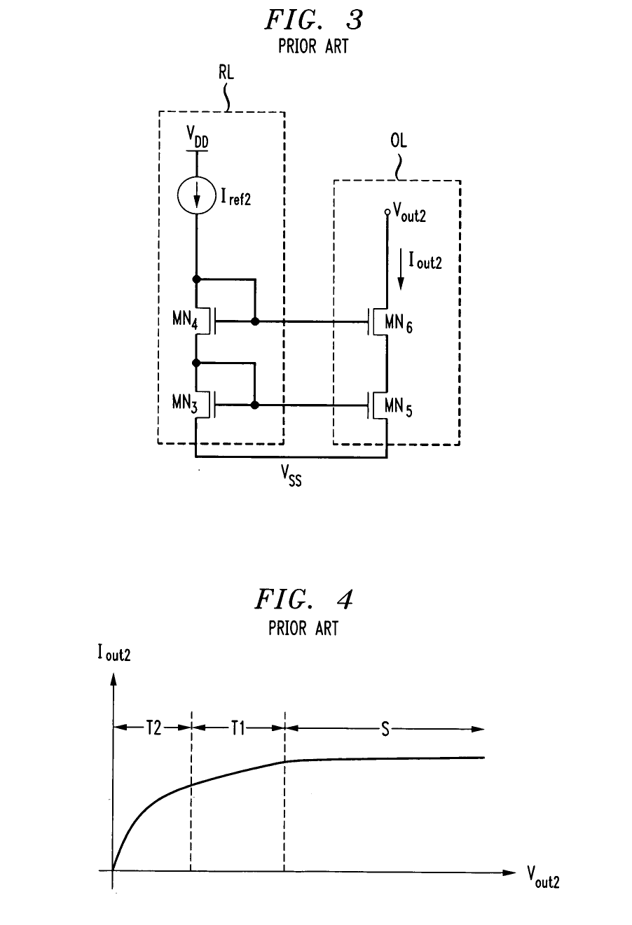

### DETAILED DESCRIPTION

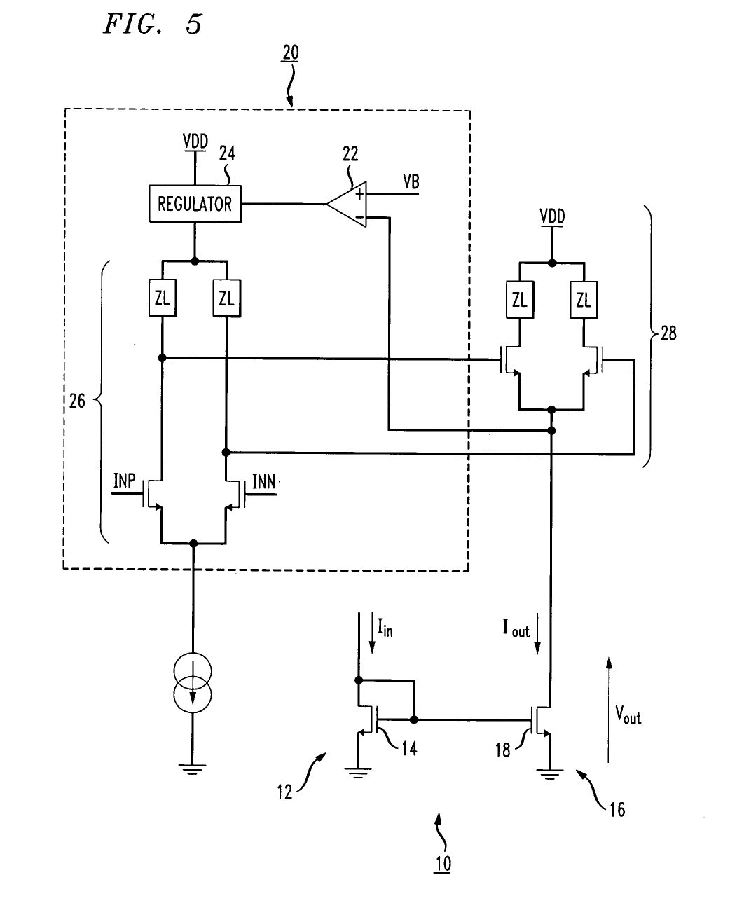

FIG. 5 illustrates an exemplary current mirror circuit 10 formed in accordance with the present invention to provide a high output impedance when used in situations powered by a relatively low voltage (on the order of, for example, V_{DD}=1.2 V or less). Current mirror 10 includes a reference branch 12 including an input reference transistor 14 that is diode-connected (that is, with the drain of transistor 14 coupled to the gate of transistor 14). Input current Iᵢₙ is shown as coupled into the drain input of input reference transistor 14. As with the prior art arrangements discussed above, current mirror 10 includes an output branch 16 along which the input current is “mirrored” to provide an output current for passing through a load. Output cascode transistor 18 is shown along output branch 16.

Comparing the arrangement of inventive current mirror circuit 10 to prior art mirror 3, it is apparent that transistor MN₆ of prior art arrangement 3 has been eliminated from the output branch, thus increasing the available “headroom” along output branch 16 by the value of one V_{DS}. The elimination of this active device, however, requires for another arrangement to be used to stabilize the drain voltage of transistor 18. In accordance with the present invention, a differential control circuit 20 is coupled to the drain of transistor 18 and is utilized to stabilize its drain voltage.

Referring to FIG. 5, control circuit 20 comprises a differential amplifier 22, with a non-inverting input coupled to bias voltage source V_{B}. The inverting input to amplifier 22 is coupled, as shown, to the drain of transistor 18 (defining output voltage V_{OUT}). The difference between V_{B} and V_{OUT} is generated at the output of amplifier 22 and used as the input to a regulator 24, which is directly coupled to power supply V_{DD}. The output of regulator 22 is applied as a common mode input to a differential amplifier 26, where the differential signals are utilized as the gate voltages for a differential amplifier 28 coupled along output branch 16. By adjusting the output common mode voltage of amplifier 28, the drain voltage at MOS device 24 can be held at a relatively constant value—without the need for an additional active device (e.g., the “prior art” need for MOS device 22).

The utilization of amplifier 22 within control circuit 20 provides the gain factor desired for the current mirror. Coupling this gain with the elimination of the V_{DS} voltage drop associated with prior art transistor MN₆ results in forming a current mirror with a relatively high output impedance, even when used with a relatively low power supply.

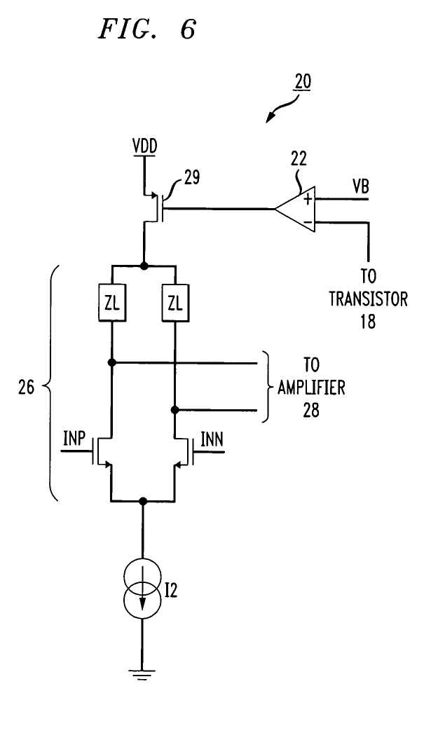

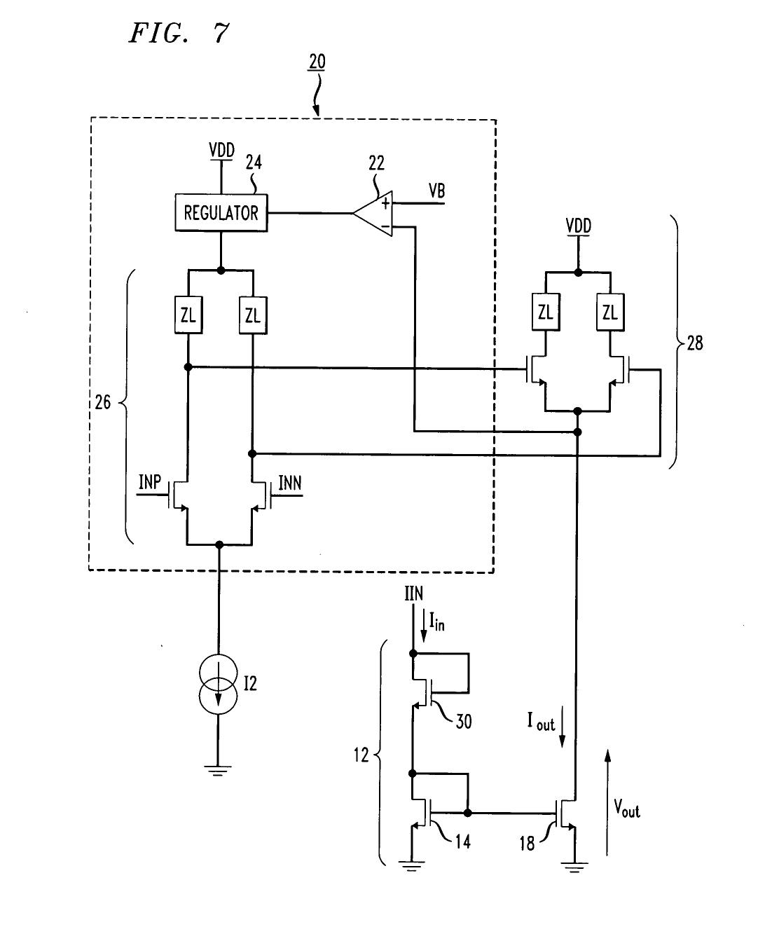

FIG. 6 illustrates a specific embodiment of control circuit 20, where regulator 24 comprises a transistor 29, with the output from amplifier 22 applied as the gate voltage to transistor 29. FIGS. 7-10 illustrate various alternative embodiments of the present invention, utilizing different interconnections and devices along the input, reference branch of the current mirror. It is to be understood that these various embodiments are considered as exemplary only, and various other suitable techniques may be used to mirror the applied current into an output branch including inventive control circuit 20.

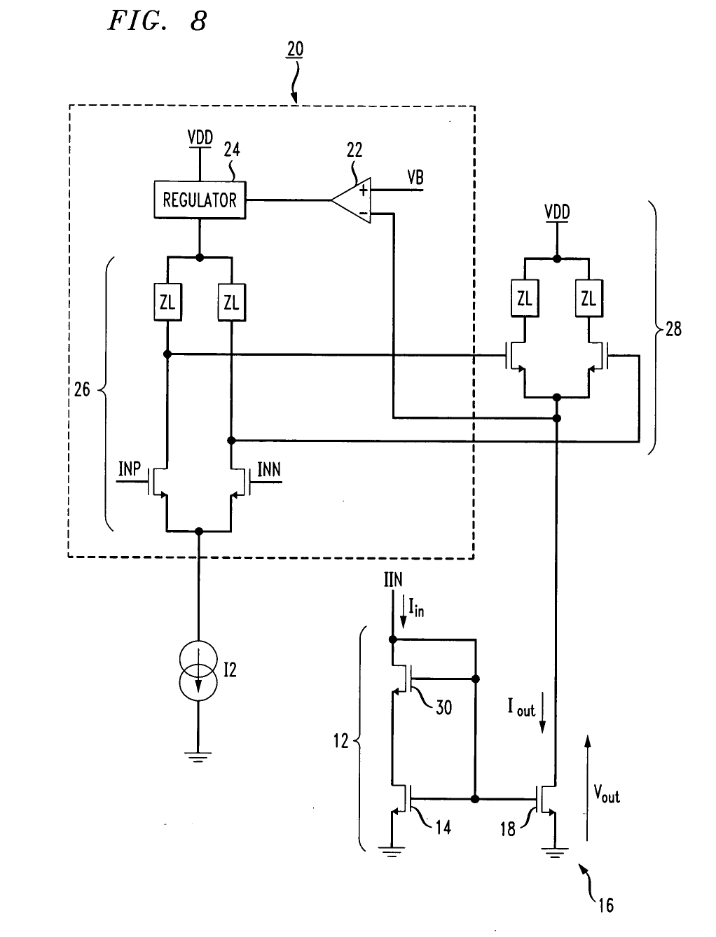

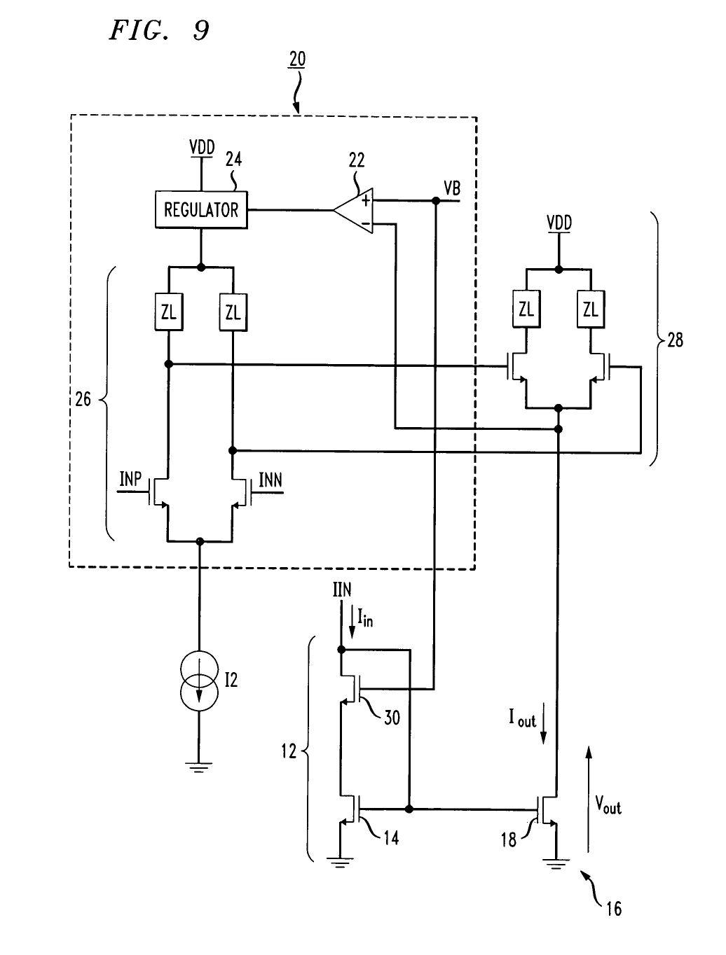

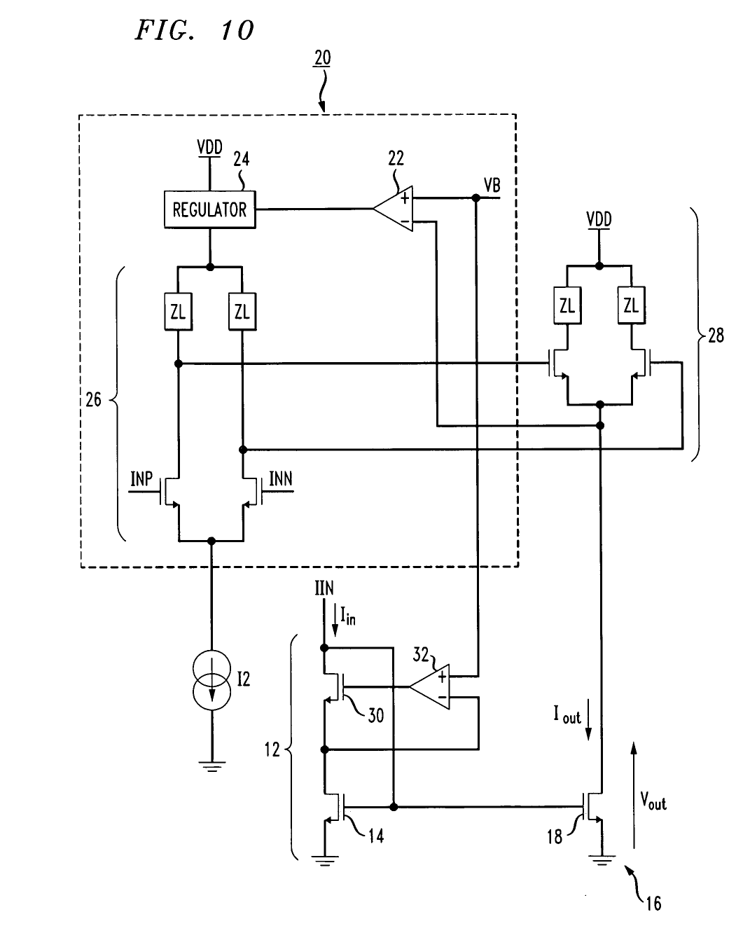

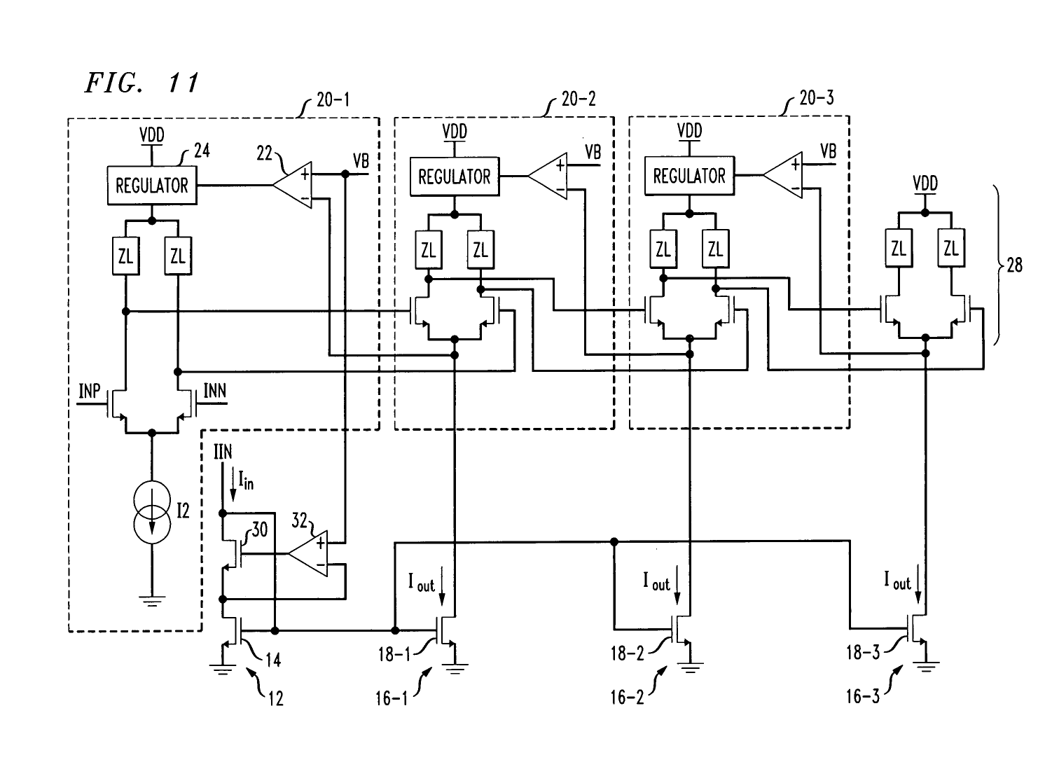

In particular, FIG. 7 illustrates an embodiment utilizing an additional input reference transistor 30 in series with reference transistor 14, where input reference transistor 30 is also diode-connected and is used to provide improved stability for input branch 12. The alternative embodiment of FIG. 8 shows input reference transistor 30 as still being diode-connected, but in this embodiment, also coupled to the gate of reference transistor 14, so that the gate of both devices is maintained at the same potential. FIG. 9 is yet another embodiment of the present invention where input reference transistor is maintained at the same bias voltage V_{B} as amplifier 22 of control circuit 20. Yet another embodiment is illustrated in FIG. 10, in this case with an amplifier 32 coupled between the gate of reference transistor 30 and the grain of input reference transistor 18. This embodiment may be preferred for situations where stability of voltage levels along the reference branch and output branch is a significant concern.

As mentioned above, the technique of the present invention may be utilized in a cascaded arrangement. FIG. 11 illustrates an exemplary multi-stage cascade arrangement 100, where a single input current I_{IN} applied along input branch 12 is “mirrored” into a set of, in this case, three separate output branches, labeled 16-1, 16-2 and 16-3. In accordance with the present invention, three separate control circuits 20-1, 20-2 and 20-3 are configured in the manner described above and utilized to control/adjust the drain voltage at each associated output branch. In this multi-stage embodiment, a single input branch 12 is utilized in conjunction with multiple output branches. It is to be understood that a set of three separate input branches may also be used.

While particular modes and embodiments of the present invention has been shown and described, numerous variations and alternative embodiments will occur to those skilled in the art. Indeed, while the above embodiments are formed of MOS devices, it is well-known that similar arrangements may be formed utilizing bipolar devices. Accordingly, it is intended that the invention be limited only in terms of the claims appended hereto.

What is claimed is:

1. A current mirror comprising
an input circuit branch including at least one reference transistor, defined as including a control input, and an input current (Iᵢₙ) applied to the at least one reference transistor;
an output circuit branch including a single transistor with a control input; and
a differential control circuit coupled between a bias voltage source (V_{B}) and the input of the single transistor forming the output circuit branch, the differential control circuit configured to adjust the common mode voltage so as to maintain the voltage across the single transistor (V_{OUT}) at an essentially constant value.

2. A current mirror as defined in claim 1 wherein the input circuit branch comprises a pair of reference transistors.

3. A current mirror as defined in claim 2 wherein at least one reference transistor of the pair of reference transistors is coupled to exhibit diode properties.

4. A current mirror as defined in claim 1 wherein the transistors comprise bipolar devices.

5. A current mirror as defined in claim 1 wherein the transistors comprise MOS devices.

6. A current mirror as defined in claim 1 wherein the differential control circuit further comprises
an amplifier coupled at a first input to the bias voltage source and at a second input to the single transistor of the output circuit branch, the output of the differential amplifier representing the difference between the bias control voltage V_{B} and V_{OUT};
a regulator coupled to the output of the differential amplifier for regulating the common mode voltage applied to the input of the output circuit branch single transistor; and
a common mode circuit responsive to the output of the regulator for providing a pair of common mode output signals.
